(19) United States
(12) Patent Application Publication
(10) Pub. No.: US 2025/0386050 A1
(43) Pub. Date: Dec. 18, 2025

(54) METHOD APPARATUS AND COMPUTER PROGRAM PRODUCT FOR SIGNALING BOUNDARY VERTICES

(71) Applicant: Nokia Technologies Oy, Espoo (FI)

(72) Inventors: Lauri Aleksi ILOLA, Tampere (FI); Lukasz KONDRAD, Munich (DE); Sebastian SCHWARZ, Munich (DE); Patrice RONDAO ALFACE, Antwerp (BE)

(21) Appl. No.: 18/879,994

(22) PCT Filed: Jun. 22, 2023
(86) PCT No.: PCT/IB2023/056476

§ 371 Date: Dec. 30, 2024

Related U.S. Application Data
(60) Provisional application No. 63/367,553, filed on Jul. 1, 2022.

(51) Int. Cl. H04N 19/597; H04N 19/70

(52) U.S. Cl. CPC H04N 19/597; H04N 19/70

(57) ABSTRACT

Various embodiments provide an apparatus, a method, and a computer program product. An example apparatus includes: at least one processor; and at least one memory including computer program code; wherein the at least one memory and the computer program code are configured to, with the at least one processor, cause the apparatus at least to: identify one or more patch boundaries; identify one or more vertices that form the one or more patch boundaries; add signaling information for the one or more vertices that form the one more patch boundaries; and encode at least one of the one or more patch boundaries, one or more vertices that form the one or more patch boundaries, or the signaling information in or along a bitstream.

### TECHNICAL FIELD

The examples and non-limiting embodiments relate generally to volumetric video coding, and more particularly, to signaling boundary vertices.

### BACKGROUND

It is known to perform coding and decoding of video and image data.

### SUMMARY

An example apparatus includes: at least one processor; and at least one memory including computer program code; wherein the at least one memory and the computer program code are configured to, with the at least one processor, cause the apparatus at least to: identify one or more patch boundaries; identify one or more vertices that form the one or more patch boundaries; add signaling information for the one or more vertices that form the one more patch boundaries; and encode at least one of the one or more patch boundaries, one or more vertices that form the one or more patch boundaries, or the signaling information in or along a bitstream.

An example apparatus includes: at least one processor; and at least one memory including computer program code; wherein the at least one memory and the computer program code are configured to, with the at least one processor, cause the apparatus at least to: encode a mesh; identify one or more patch boundaries from the mesh; identify one or more vertices that form the one or more patch boundaries; add signaling information for the one or more vertices that form the one more patch boundaries; and encode the one or more patch boundaries, one or more vertices that form the one or more patch boundaries, or signaling information in or along a bitstream.

The example apparatus may further include, wherein the apparatus is further caused to signal the bitstream to a decoder.

The example apparatus may further include, wherein to add the signaling information, the apparatus is caused to: extend a syntax of a mesh patch data unit; and wherein to encode the signaling information, the apparatus is caused to encode the mesh patch data unit in a sub-bitstream, and wherein the bitstream comprises the sub-bitstream.

The example apparatus may further include, wherein a value of ‘0’ for the signaling information indicates that the vertex identified in a tile ID and a patch Id does not belong on a border of a patch, and wherein a value of ‘1’ for the signaling information indicates that the vertex belongs on the border of the patch.

The example apparatus may further include, wherein the bitstream comprises a V3C bitstream, and the sub-bitstream comprises an atlas sub-bitstream.

The example apparatus may further include, wherein to identify the one or more patch boundaries the apparatus is caused to: compare vertex indices between different patches comprised in the mesh during the encoding process.

The example apparatus may further include, wherein to identify the one or more patch boundaries the apparatus is further caused to: analyze an encoded mesh, wherein a mesh comprises one or more patches, and wherein to analyze the encoded mesh, the apparatus is caused to compare vertex indices comprised in the one or more mesh patch data units.

The example apparatus may further include, wherein the apparatus is further caused to perform a connectivity analysis of the one or more patches comprised in the mesh.

The example apparatus may further include, wherein to perform the connectivity analysis, the apparatus is further caused to perform the following algorithm: for each edge (e) comprising vertices (v0, v1) in a set of edges of the mesh (E): when the e is connected to one polygon (P), e is a boundary edge, and v0 and v1 are boundary vertices for a patch comprising P; when e is connected to two polygons (P1 and P2): when P1 and P2 belong to different patches, e is a boundary edge; when P1 and P2 do not belong to the different patches, e is not a boundary edge; wherein for each detected boundary edge e comprising vertices indices v0 and v1, v0 and v1 are set as boundary vertices.

The example apparatus may further include, wherein apparatus is further caused to: receive or generate a mesh; and generate the one or more patches.

The example apparatus may further include, wherein to add the signaling information the apparatus is caused to use one or more flags.

The example apparatus may further include, wherein the apparatus is further caused to identify the one or more patches from the mesh.

Another example apparatus includes: at least one processor; and at least one memory including computer program code; wherein the at least one memory and the computer program code are configured to, with the at least one processor, cause the apparatus at least to: receive a bitstream comprising signaling information for indicating one or more vertices that form one more patch boundaries; parse the bitstream; and identify the one or more vertices that form the one more patch boundaries based on the parsing of the bitstream.

The apparatus may further include, wherein a mesh patch data unit comprises the signaling information, and wherein the bitstream comprises the mesh patch data unit, and wherein to the parse the bitstream, the apparatus is further caused to parse the mesh patch data unit.

The apparatus may further include, wherein bitstream further comprises the one or more patch boundaries.

The apparatus may further include, wherein the bitstream further comprises the one or more vertices that form the one or more patch boundaries.

Yet another example apparatus includes: at least one processor; and at least one memory including computer program code; wherein the at least one memory and the computer program code are configured to, with the at least one processor, cause the apparatus at least to: receive a bitstream, the bitstream comprising an encoded presentation of a mesh; receive, from or along the bitstream, information for one or more vertices that form one more patch boundaries; decode, from the bitstream, two or more components of a volumetric video content; unpack one or more patches from depacking the two or more components of the volumetric video content from separate patches by using separate settings and patch information.

The example apparatus may further include, wherein the two or more components comprise two or more of an occupancy, a geometry, an attribute, a mesh component, or a displacement component.

An example method includes: identifying one or more patch boundaries; identifying one or more vertices that form the one or more patch boundaries; adding signaling information for the one or more vertices that form the one more patch boundaries; and encoding at least one of the one or more patch boundaries, one or more vertices that form the one or more patch boundaries, or the signaling information in or along a bitstream.

An example method includes: encoding a mesh; identifying one or more patch boundaries from the mesh; identifying one or more vertices that form the one or more patch boundaries; adding signaling information for the one or more vertices that form the one more patch boundaries; and encoding the one or more patch boundaries, one or more vertices that form the one or more patch boundaries, or signaling information in or along a bitstream.

The example method may further include signaling the bitstream to a decoder.

The example method may further include, wherein adding the signaling information comprises extending a syntax of a mesh patch data unit; and wherein encoding the signaling information comprises encoding the mesh patch data unit in a sub-bitstream, and wherein the bitstream comprises the sub-bitstream.

The example method may further include, wherein a value of ‘0’ for the signaling information indicates that the vertex identified in a tile ID and a patch Id does not belong on a border of a patch, and wherein a value of ‘1’ for the signaling information indicates that the vertex belongs on the border of the patch.

The example method may further include, wherein the bitstream comprises a V3C bitstream, and the sub-bitstream comprises an atlas sub-bitstream.

The example method may further include, wherein identifying the one or more patch boundaries comprises: comparing vertex indices between different patches comprised in the mesh during the encoding process.

The example method may further include, wherein to identify the one or more patch boundaries comprises: analyzing an encoded mesh, wherein a mesh comprises one or more patches, and wherein analyzing the encoded mesh comprises comparing vertex indices comprised in the one or more mesh patch data units.

The example method may further include, further comprising performing a connectivity analysis of the one or more patches comprised in the mesh.

The example method may further include, wherein to performing the connectivity analysis comprises performing the following algorithm: for each edge (e) comprising vertices (v0, v1) in a set of edges of the mesh (E): when the e is connected to one polygon (P), e is a boundary edge, and v0 and v1 are boundary vertices for a patch comprising P; when e is connected to two polygons (P1 and P2): when P1 and P2 belong to different patches, e is a boundary edge; when P1 and P2 do not belong to the different patches, e is not a boundary edge; wherein for each detected boundary edge e comprising vertices indices v0 and v1, v0 and v1 are set as boundary vertices.

The example method may further include: receiving or generating a mesh; and generating the one or more patches.

The example method may further include, wherein adding the signaling information comprises using one or more flags.

The example method may further include identifying the one or more patches from the mesh.

Another example method includes: receiving a bitstream comprising signaling information for indicating one or more vertices that form one more patch boundaries; parsing the bitstream; and identifying the one or more vertices that form the one more patch boundaries based on the parsing of the bitstream.

The example method may further include, wherein a mesh patch data unit comprises the signaling information, and wherein the bitstream comprises the mesh patch data unit, and wherein parsing the bitstream comprises parsing the mesh patch data unit.

The example method may further include, wherein bitstream further comprises the one or more patch boundaries.

The example method may further include, wherein the bitstream further comprises the one or more vertices that form the one or more patch boundaries.

Yet another method includes: receiving a bitstream, the bitstream comprising an encoded presentation of a mesh; receiving, from or along the bitstream, information for one or more vertices that form one more patch boundaries; decoding, from the bitstream, two or more components of a volumetric video content; unpacking one or more patches from depacking the two or more components of the volumetric video content from separate patches by using separate settings and patch information.

The example method may further include, wherein the two or more components comprise two or more of an occupancy, a geometry, an attribute, a mesh component, or a displacement component.

An example computer readable medium includes program instructions for causing an apparatus to perform methods as described in any of the previous paragraphs.

The example computer readable medium includes, wherein the computer readable medium comprises a non-transitory computer readable medium.

A still another example apparatus includes means for performing the methods as described in any of the previous paragraphs.

### BRIEF DESCRIPTION OF THE DRAWINGS

The foregoing aspects and other features are explained in the following description, taken in connection with the accompanying drawings, wherein:

FIG. 1A shows an example process for encoding volumetric media.

FIG. 1B shows an example process for decoding volumetric media.

FIG. 2 shows an example of block to patch mapping.

FIG. 3A shows an example of an atlas coordinate system.

FIG. 3B shows an example of a local 3D patch coordinate system.

FIG. 3C shows an example of a final target 3D coordinate system.

FIG. 4 shows elements of a mesh.

FIG. 5 shows an example V-PCC extension for mesh encoding, based on the embodiments described herein.

FIG. 6 shows an example V-PCC extension for mesh decoding, based on the embodiments described herein.

FIG. 7 illustrates subdivision of a triangle into four triangles.

FIG. 8 illustrates a multi-resolution analysis of a mesh.

FIG. 9 illustrates an encoder comprising a pre-processing module or circuit.

FIG. 10 illustrates sub-modules or circuits of the pre-processing module.

FIG. 11 illustrates intra frame encoder scheme.

FIG. 12 illustrates inter frame encoder scheme.

FIG. 13 illustrates a decoding module or circuit.

FIG. 14 illustrates intra process decoding scheme.

FIG. 15 illustrates inter process decoding scheme.

FIG. 16 illustrates visualization of patches on a base mesh.

FIG. 17 illustrates an original mesh, a decimated base mesh, and a reconstructed mesh after applying a global subdivision modifier.

FIG. 18 illustrates cracks between triangles TO and T1 after applying subdivision modifier to one triangle.

FIG. 19 describes a method for signaling information for vertices that form patch boundaries, in accordance with an embodiment.

FIG. 20 illustrates extended syntax element, in accordance with an embodiment.

FIG. 21 is an apparatus which may be implemented in hardware, configured to implement signaling or receiving boundary vertices, based on any of the examples described herein.

FIG. 22 is method to implement the examples described herein, in accordance with an embodiment.

FIG. 23 is method to implement the examples described herein, in accordance with another embodiment.

FIG. 24 is a method to implement the examples described herein, in accordance with an embodiment.

### DETAILED DESCRIPTION OF EXAMPLE EMBODIMENTS

The examples described herein relate to the encoding, signaling, and/or rendering a volumetric video based on mesh coding.

### Volumetric Video Data

Volumetric video data represents a three-dimensional scene or object and can be used as input for AR, VR and MR applications. Such data describes geometry (shape, size, position in 3D-space) and respective attributes (e.g. color, opacity, reflectance, . . . ), plus any possible temporal transformations of the geometry and attributes at given time instances (like frames in 2D video). Volumetric video is either generated from 3D models, i.e. CGI, or captured from real-world scenes using a variety of capture solutions, e.g. multi-camera, laser scan, combination of video and dedicated depth sensors, and more. Also, a combination of CGI and real-world data is possible. Typical representation formats for such volumetric data are polygon meshes, point clouds, or voxels. Temporal information about the scene can be included in the form of individual capture instances, i.e. “frames” in 2D video, or other means, e.g. position of an object as a function of time.

Because volumetric video describes a 3D scene (or object), such data can be viewed from any viewpoint. Therefore, volumetric video is an important format for any AR, VR, or MR application, especially for providing 6DOF viewing capabilities.

Increasing computational resources and advances in 3D data acquisition devices have enabled reconstruction of highly detailed volumetric video representations of natural scenes. Infrared, lasers, time-of-flight and structured light are all examples of devices that can be used to construct 3D video data. Representation of the 3D data depends on how the 3D data is used. Dense voxel arrays have been used to represent volumetric medical data. In 3D graphics, polygonal meshes are extensively used. Point clouds on the other hand are well suited for applications such as capturing real world 3D scenes where the topology is not necessarily a 2D manifold. Another way to represent 3D data is coding this 3D data as a set of texture and depth map(s) as is the case in the multi-view plus depth. Closely related to the techniques used in multi-view plus depth is the use of elevation maps, and multi-level surface maps.

### MPEG Visual Volumetric Video-Based Coding (V3C)

The following described examples refer to excerpts of ISO/IEC 23090-5 Visual Volumetric Video-based Coding and Video-based Point Cloud Compression 2nd Edition.

Visual volumetric video, a sequence of visual volumetric frames, when uncompressed, may be represented by a large amount of data, which can be costly in terms of storage and transmission. This has led to the need for a high coding efficiency standard for the compression of visual volumetric data.

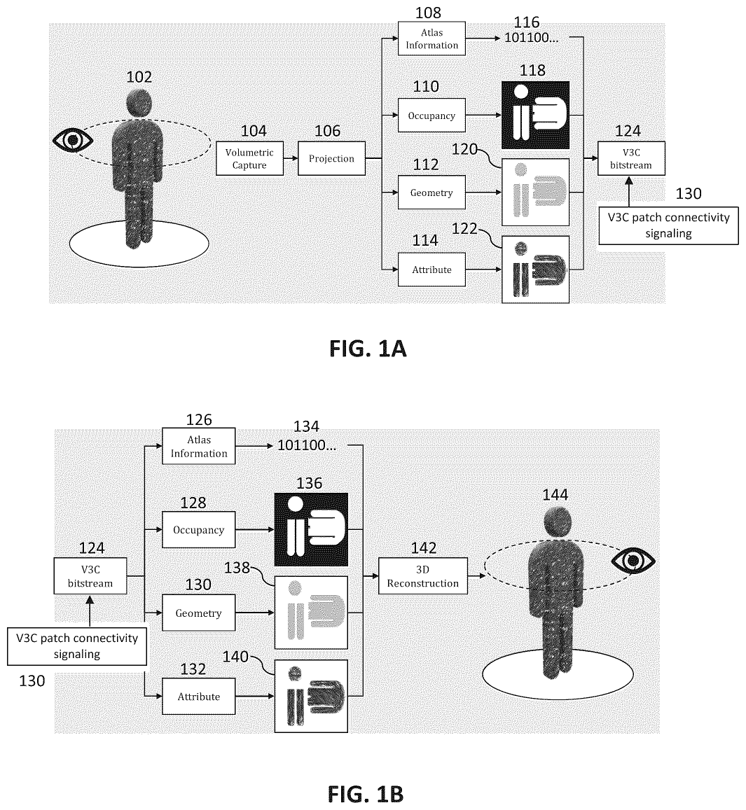

V3C specification enables the encoding and decoding processes of a variety of volumetric media by using video and image coding technologies. This is achieved through first a conversion of such media from their corresponding 3D representation to multiple 2D representations, also referred to as V3C components, before coding such information. Such representations may include occupancy, geometry, and attribute components. The occupancy component can inform a V3C decoding and/or rendering system of which samples in the 2D components are associated with data in the final 3D representation. The geometry component contains information about the precise location of 3D data in space, while attribute components can provide additional properties, e.g. texture or material information, of such 3D data. An example is shown in FIG. 1A and FIG. 1B.

FIG. 1A shows volumetric media conversion at the encoder, and FIG. 1B shows volumetric media conversion at the decoder side. The 3D media 102 is converted to a series of 2D representations: occupancy 118, geometry 120, and attributes 122. Additional atlas information 108 is also included in the bitstream to enable inverse reconstruction. Refer to ISO/IEC 23090-5.

As further shown in FIG. 1A, a volumetric capture operation 104 generates a projection 106 from the input 3D media 102. In some examples, the projection 106 is a projection operation. From the projection 106, an occupancy operation 110 generates the occupancy 2D representation 118, a geometry 112 operation generates the geometry 2D representation 120, and an attribute operation 114 generates the attribute 2D representation 122. The additional atlas information 108 is included in the bitstream 116. The atlas information 108, the occupancy 2D representation 118, the geometry 2D representation 120, and the attribute 2D representation 122 are encoded into the V3C bitstream 124 to encode a compressed version of the 3D media 102. Based on the examples described herein, 130 may also be signaled in the V3C bitstream 124. The V3C patch connectivity signaling 130 may be used on the decoder side, as shown in FIG. 1B.

As shown in FIG. 1B, a decoder using the V3C bitstream 124 derives 2D representations using an atlas information operation 126, an occupancy operation 128, a geometry operation 130 and an attribute operation 132. The atlas information operation 126 provides atlas information into a bitstream 134. The occupancy operation 128 derives the occupancy 2D representation 136, the geometry operation 130 derives the geometry 2D representation 138, and the attribute operation 132 derives the attribute 2D representation 140. The 3D reconstruction operation 142 generates a decompressed reconstruction 144 of the 3D media 102, using the atlas information 126/134, the occupancy 2D representation 136, the geometry 2D representation 138, and the attribute 2D representation 140.

Additional information that allows associating all these subcomponents and enables the inverse reconstruction, from a 2D representation back to a 3D representation is also included in a special component, referred to in this document as the atlas. An atlas consists of multiple elements, named as patches. Each patch identifies a region in all available 2D components and contains information necessary to perform the appropriate inverse projection of this region back to the 3D space. The shape of such regions is determined through a 2D bounding box associated with each patch as well as their coding order. The shape of these regions is also further refined after the consideration of the occupancy information.

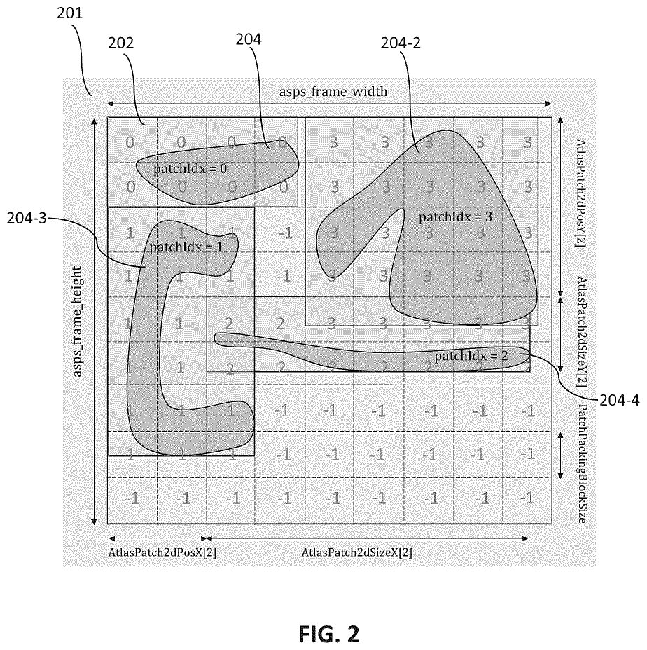

Atlases are partitioned into patch packing blocks of equal size. Refer for example to block 202 in FIG. 2. The 2D bounding boxes of patches and their coding order determine the mapping between the blocks of the atlas image and the patch indices. FIG. 2 shows an example of block to patch mapping with 4 projected patches (204, 204-2, 204-3, 204-4) onto an atlas 201 when asps_patch_precedence_order_flag is equal to 0. Projected points are represented with dark grey. The area that does not contain any projected points is represented with light grey. Patch packing blocks are represented with dashed lines. The number inside each patch packing block 202 represents the patch index of the patch to which it is mapped. Refer to ISO/IEC 23090-5.

Axes orientations are specified for internal operations. For instance, the origin of the atlas coordinates is located on the top-left corner of the atlas frame. For the reconstruction step, an intermediate axes definition for a local 3D patch coordinate system is used. The 3D local patch coordinate system is then converted to the final target 3D coordinate system using appropriate transformation steps.

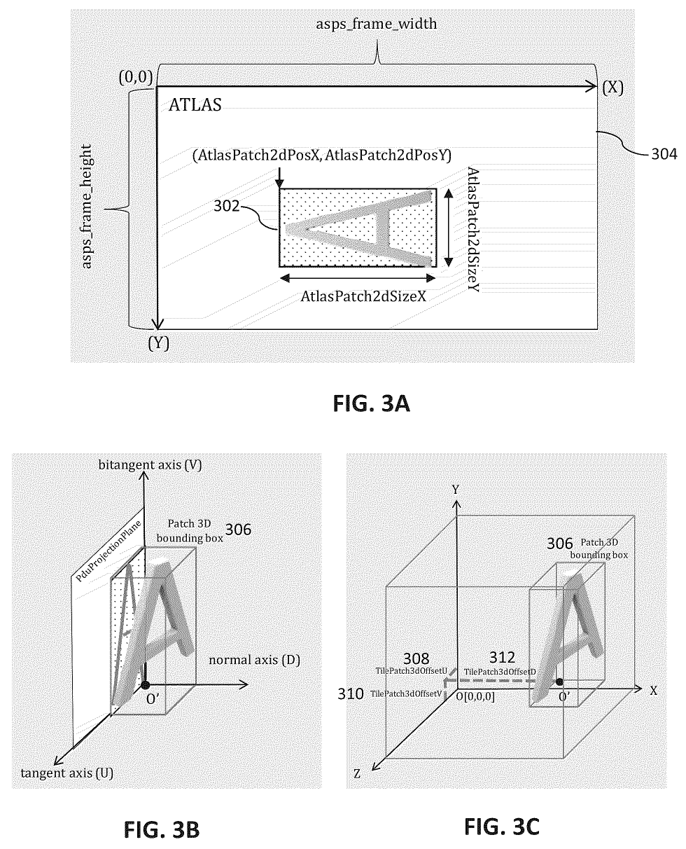

FIG. 3A shows an example of a single patch 302 packed onto an atlas image 304. This patch is then converted, with reference to FIG. 3B, to a local 3D patch coordinate system (U, V, D) defined by the projection plane with origin O′, tangent (U), bi-tangent (V), and normal (D) axes. For an orthographic projection, the projection plane is equal to the sides of an axis-aligned 3D bounding box 306, as shown in FIG. 3B. The location of the bounding box 306 in the 3D model coordinate system, defined by a left-handed system with axes (X, Y, Z), can be obtained by adding offsets TilePatch3dOffsetU 308, TilePatch3DOffsetV 310, and TilePatch3DOffsetD 312, as illustrated in FIG. 3C.

Accordingly, FIG. 3A shows an example of an atlas coordinate system, FIG. 3B shows an example of a local 3D patch coordinate system, and FIG. 3C shows an example of a final target 3D coordinate system. Refer to ISO/IEC 23090-5.

### V3C High Level Syntax

Coded V3C video components are referred to in this document as video bitstreams, while an atlas component is referred to as the atlas bitstream. Video bitstreams and atlas bitstreams may be further split into smaller units, referred to here as video and atlas sub-bitstreams, respectively, and may be interleaved together, after the addition of appropriate delimiters, to construct a V3C bitstream.

V3C patch information is contained in atlas bitstream, atlas_sub_bitstream( ) which contains a sequence of NAL units NAL unit is specified to format data and provide header information in a manner appropriate for conveyance on a variety of communication channels or storage media. All data are contained in NAL units, each of which contains an integer number of bytes. A NAL unit specifies a generic format for use in both packet-oriented and bitstream systems. The format of NAL units for both packet-oriented transport and sample streams is identical except that in the sample stream format specified in Annex D of ISO/IEC 23090-5 each NAL unit can be preceded by an additional element that specifies the size of the NAL unit.

NAL units in atlas bitstream can be divided to atlas coding layer (ACL) and non-atlas coding layer (non-ACL) units. The former dedicated to carry patch data while the later to carry data necessary to properly parse the ACL units or any additional auxiliary data.

In the nal_unit_header( ) syntax nal_unit_type specifies the type of the RBSP data structure contained in the NAL unit as specified in Table 4 of ISO/IEC 23090-5. nal_layer_id specifies the identifier of the layer to which an ACL NAL unit belongs or the identifier of a layer to which a non-ACL NAL unit applies. The value of nal_layer_id shall be in the range of 0 to 62, inclusive. The value of 63 may be specified in the future by ISO/IEC. Decoders conforming to a profile specified in Annex A of ISO/IEC 23090-5 shall ignore (e.g., remove from the bitstream and discard) all NAL units with values of nal_layer_id not equal to 0.

### V3C Extension Mechanisms

While designing V3C specification it was envisaged that amendments or new editions can be created in the future. In order to ensure that the first implementations of V3C decoders are compatible with any future extension, a number of fields for future extensions to parameter sets were reserved.

For example, as illustrated in table below, a second edition of V3C introduced an extension in VPS related to MIV and packed video component.

| | |
|---|---|
| ... | |
| vps_extension_present_flag | u(1) |
| if( vps_extension_present_flag ) { | |
| vps_packing_information_present_flag | u(1) |
| vps_miv_extension_present_flag | u(1) |
| vps_extension_6bits | u(6) |
| } | |
| if( vps_packing_information_present_flag ) { | |
| for( k = 0 ; k <= vps_atlas_count_minus1; k++ ) { | |
| j = vps_atlas_id[ k ] | |
| vps_packed_video_present_flag[ j ] | |
| if( vps_packed_video_present_flag[ j ] ) | |
| packing_information( j ) | |
| } | |
| } | |
| if( vps_miv_extension_present_flag ) | |
| vps_miv_extension( ) /*Specified in | |
| ISO/IEC 23090-12¹ */ | |
| if( vps_extension_6bits ) { | |
| vps_extension_length_minus1 | ue(v) |
| for( j = 0; j < vps_extension_length_minus1 + 1; j | |
| ++ ) { | |
| vps_extension_data_byte | u(8) |
| } | |
| } | |
| byte_alignment( ) | |
| } | |

### Rendering and Meshes

A polygon mesh is a collection of vertices, edges and faces that defines the shape of a polyhedral object in 3D computer graphics and solid modelling. The faces usually consist of triangles (triangle mesh), quadrilaterals (quads), or other simple convex polygons (n-gons), since this simplifies rendering, but may also be more generally composed of concave polygons, or even polygons with holes.

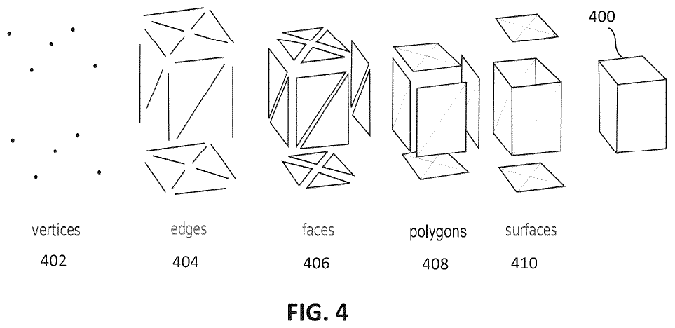

With reference to FIG. 4, objects 400 created with polygon meshes are represented by different types of elements. These include vertices 402, edges 404, faces 406, polygons 408and surfaces 410 as shown in FIG. 4. Thus, FIG. 4 illustrates elements of a mesh.

Polygon meshes are defined at least by the following elements:
Vertex (402): A position in 3D space defined as (x, y, z) along with other information such as color (r, g, b), normal vector and texture coordinates.
Edge (404): A connection between two vertices.
Face (406): A closed set of edges, in which a triangle face has three edges, and a quad face has four edges. A polygon 408 is a coplanar set of faces 406. In systems that support multi-sided faces, polygons and faces are equivalent. Mathematically a polygonal mesh may be considered an unstructured grid, or undirected graph, with additional properties of geometry, shape and topology.
Surfaces (410): or smoothing groups, are useful, but not required to group smooth regions.
Groups: Some mesh formats contain groups, which define separate elements of the mesh, and are useful for determining separate sub-objects for skeletal animation or separate actors for non-skeletal animation.
Materials: defined to allow different portions of the mesh to use different shaders when rendered.
UV coordinates: Most mesh formats also support some form of UV coordinates which are a separate 2D representation of the mesh “unfolded” to show what portion of a 2-dimensional texture map to apply to different polygons of the mesh. It is also possible for meshes to contain other such vertex attribute information such as color, tangent vectors, weight maps to control animation, etc. (sometimes also called channels).

### V-PCC Mesh Coding Extension (MPEG M49588)

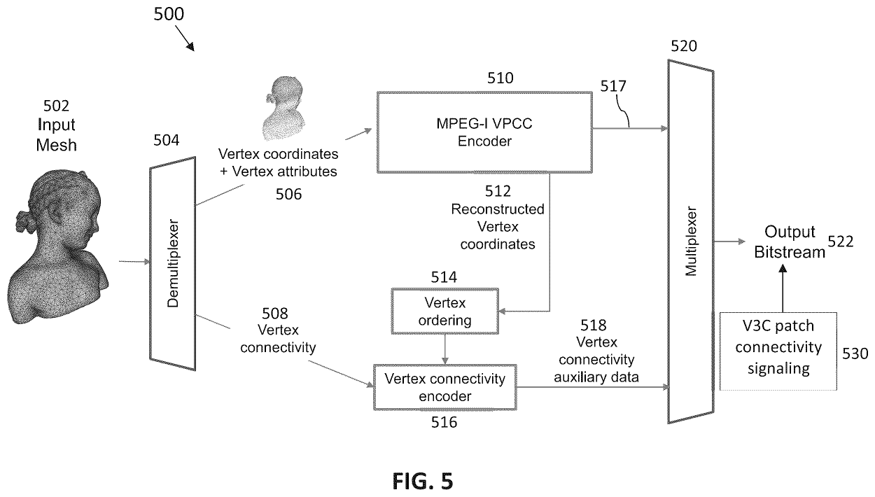

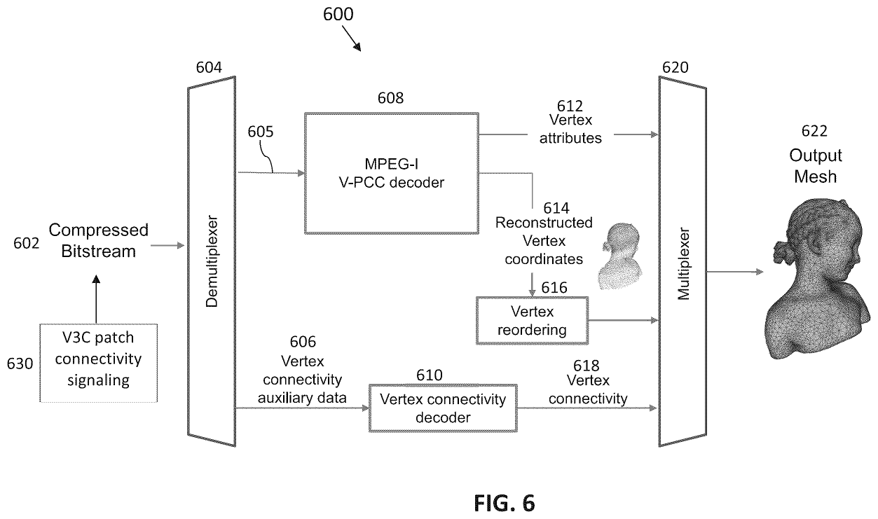

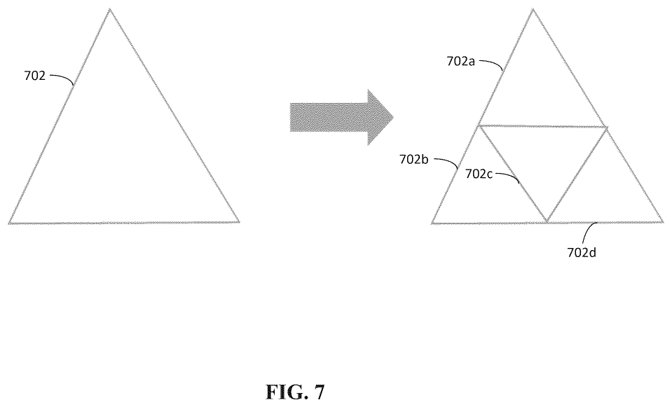

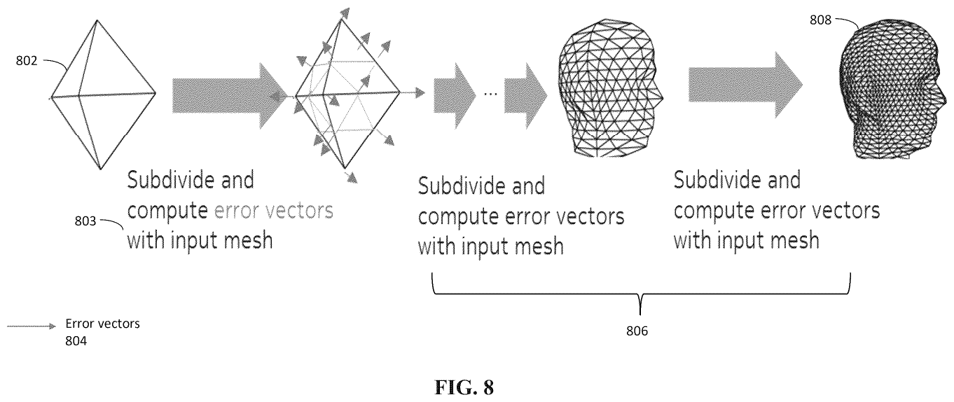

FIG. 5 and FIG. 6 show the extensions to the V-PCC encoder and decoder to support mesh encoding and mesh decoding, respectively.

In the encoder extension 500, the input mesh data 502 is demultiplexed 504 into vertex coordinate+attributes 506 and vertex connectivity 508. The vertex coordinate+attributes data 506 is coded 510 using MPEG-I V-PCC, whereas the vertex connectivity data 508 is coded (using vertex connectivity encoder 516) as auxiliary data 518. Both of these (encoded vertex coordinates and vertex attributes 517 and auxiliary data 518) are multiplexed 520 to create the final compressed output bitstream 522. Vertex ordering 514 is carried out on the reconstructed vertex coordinates 512 at the output of MPEG-I V-PCC 510 to reorder the vertices for optimal vertex connectivity encoding 516.

Based on the examples described herein, as shown in FIG. 5, the encoding process/apparatus 500 of FIG. 5 may be extended such that the encoding process/apparatus 500 signals V3C patch connectivity signaling 530 within the output bitstream 522. Alternatively, V3C patch connectivity signaling 530 may be provided and signaled separately from the output bitstream 522.

As shown in FIG. 6, in the decoder 600, the input bitstream 602 is demultiplexed 604 to generate the compressed bitstreams for vertex coordinates+attributes 605 and vertex connectivity 606. The input/compressed bitstream 602 may comprise or may be the output from the encoder 500, namely the output bitstream 522 of FIG. 5. The vertex coordinates+attributes 605 is decompressed using MPEG-I V-PCC decoder 608 to generate vertex attributes 612. Vertex ordering 616 is carried out on the reconstructed vertex coordinates 614 at the output of MPEG-I V-PCC decoder 608 to match the vertex order at the encoder 500. The vertex connectivity data 606 is also decompressed using vertex connectivity decoder 610 to generate vertex connectivity 618, and everything (including vertex attributes 612, the output of vertex reordering 616, and vertex connectivity 618) is multiplexed 620 to generate the reconstructed mesh 622.

Based on the examples described herein, as shown in FIG. 6, the decoding process/apparatus 600 of FIG. 6 may be extended such that the decoding process/apparatus 600 receives and decodes V3C patch connectivity signaling 630, which may be part of the compressed bitstream 622. Alternatively, V3C patch connectivity signaling 630 may be received and signaled separately from the compressed bitstream 602 or output bitstream 522. The V3C patch connectivity signaling 630 of FIG. 6 may comprise or correspond to the V3C patch connectivity signaling 530 of FIG. 5

### Generic Mesh Compression

Mesh data may be compressed directly without projecting it into 2D-planes, like in V-PCC based mesh coding. In fact, the anchor for V-PCC mesh compression call for proposals (CfP) utilizes off-the shelf mesh compression technology, Draco (https://google.github.io/draco/), for compressing mesh data excluding textures. Draco is used to compress vertex positions in 3D, connectivity data (faces) as well as UV coordinates. Additional per-vertex attributes may be also compressed using draco. The actual UV texture may be compressed using traditional video compression technologies, such as H.265 or H.264.

Draco uses the Edgebreaker algorithm at its core to compress 3D mesh information. It offers a good balance between simplicity and efficiency, and is part of Khronos endorsed extensions for the glTF specification. The main idea of the algorithm is to traverse mesh triangles in a deterministic way so that each new triangle is encoded next to an already encoded triangle. This enables prediction of vertex specific information from the previously encoded data by simply adding delta to the previous data. Edgebreaker utilizes symbols to signal how each new triangle is connected to the previously encoded part of the mesh. Connecting triangles in such a way results on average in 1 to 2 bits per triangle when combined with existing binary encoding techniques.

### V-DMC

The V-DMC standardization works have started after the completion of the call for proposal (CfP) issued by MPEG 3DG (ISO/IEC SC29 WG 2) on integration of MESH compression into the V3C family of standards (ISO/IEC 23090-5). The retained technology after the CfP result analysis is based on multiresolution mesh analysis and coding. This approach includes:
generating a base mesh that is a simplified (low resolution) mesh approximation of the original mesh, called base mesh (this is done for all frames of the dynamic mesh sequence) mᵢ
performing several mesh subdivision iterative steps (e.g., a triangle 702 is converted into four triangles 702a, 702b, 702c, and 702d, by connecting the triangle edge midpoints as illustrated in FIG. 7 (illustrates subdivision of a triangle into four triangles) on the generated base mesh, generating other approximation meshes mⁿᵢ where n stands for the number of iterations with mᵢ=m⁰ᵢ
defining displacement vectors dᵢ, also named error vectors, for each vertex of each mesh approximation mⁿᵢ with n>0, noted dⁿᵢ
For each subdivision level, the deformed mesh, obtained by mⁿᵢ+dⁿᵢ, e.g., by adding the displacement vectors to the subdivided mesh vertices generates, for example, the best approximation of the original mesh at that resolution, given the base mesh and prior subdivision levels.
The displacement vectors, may undergo a lazy wavelet transform prior to compression.
The attribute map of the original mesh is transferred to the deformed mesh at, for example, the highest resolution (e.g., subdivision level) such that texture coordinates are obtained for the deformed mesh and a new attribute map is generated.

FIG. 8 illustrates a multi-resolution analysis of a mesh. A base mesh 802 undergoes a first step of subdivision 803 and error vectors 804 are added to each vertex. After a series of iterative subdivision and displacements 806, a highest resolution mesh is generated 808. A connectivity of highest resolution deformed mesh is generally different from an original mesh, however, the geometry of the deformed mesh is a good approximation of the original mesh geometry.

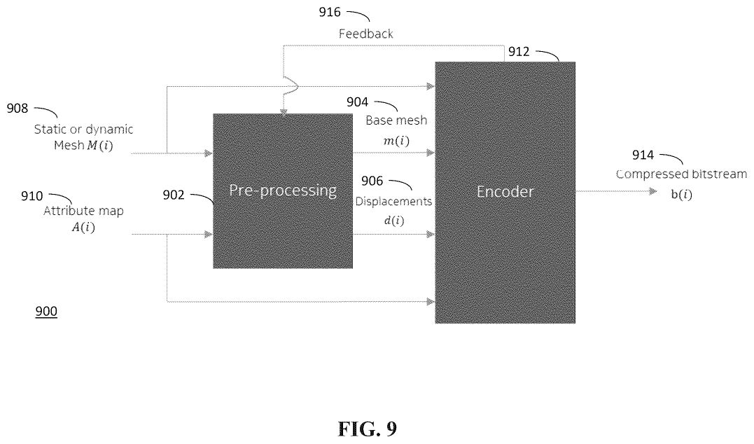

The encoding process may be separated into following example modules: a pre-processing module and an actual encoder module as illustrated on FIG. 9.

FIG. 9 illustrates an encoder 900 comprising a pre-processing module or circuit 902. The pre-processing module 902 that generates a base mesh 904 and the displacement vectors 906, given the input mesh sequence 908 and attribute maps 910 of the input mesh sequence 908. The encoder module or circuit 912 generates a compressed bitstream 914 by ingesting the inputs and outputs of the pre-processing module 902.

In an embodiment, the encoder 900 includes a feedback loop 916. The feedback loop 916 may be used to signal information to the pre-processing module 902 and change its parameters to achieve the best possible compromise according to various criteria, including but not limited, to following:
Rate-distortion;
Encode/decode complexity;
Random access;
Reconstruction complexity;
Terminal capabilities;
Encode/decode power consumption; and
Network bandwidth and latency.

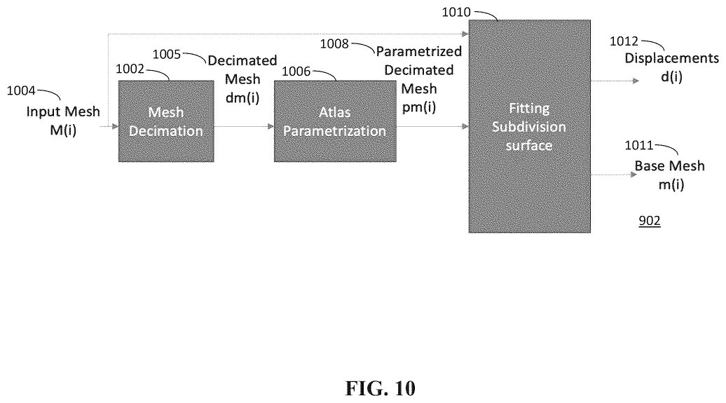

FIG. 10 illustrates sub-modules or circuits of the pre-processing module 902. The pre-processing module 902 includes, for example: a mesh decimation module or circuit 1002 for reducing the resolution of the original mesh or input mesh 1004 to produce a decimated mesh 1005, a uv-atlas isocharting module or circuit 1006 a for creating parameterization or parameterized decimated mesh 1008 of the decimated mesh 1005, and a subdivision surface fitting module a base mesh 1011 and or circuit 1010 for generating displacement vectors 1012.

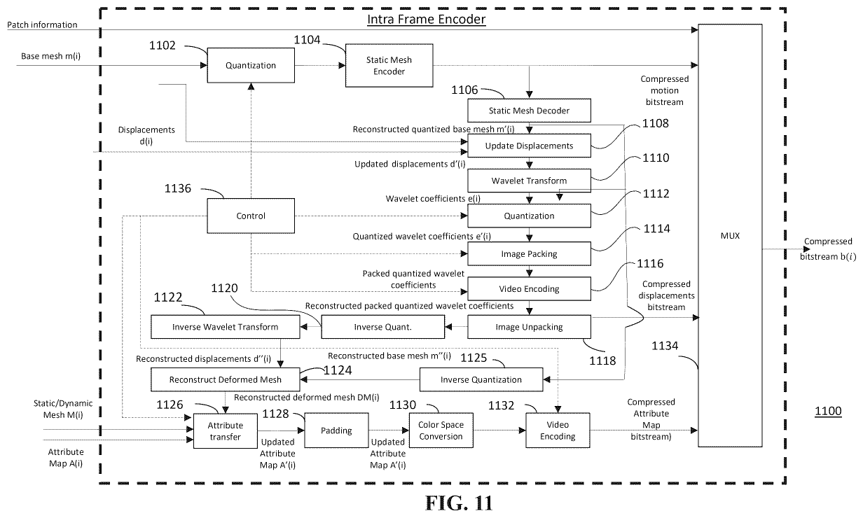

FIG. 11 illustrates intra frame encoder scheme 1100. The intra frame encoder scheme 1100 includes following:
Quantization module or circuit 1102: The base mesh m(i) associated with a current frame is first quantized by the quantization module or circuit 1102 (e.g., using uniform quantization);
Static mesh encoder 1104: The quantized base mesh is then encoded by using a static mesh encoder 1104. The scheme is agnostic of which mesh encoding scheme is used to compress the base mesh. Mesh codecs may, for example, be Draco, T-Fan, and the like;
Static mesh decoder 1106: the static mesh decoder 1106 is associated with the static mesh encoder 1104 and decodes the encoded quantized base mesh; the subsequent operations are based on reconstructed values of the decoded base mesh.
Update displacements module or circuit 1108: Depending on the application and the targeted bitrate/visual quality, the encoder may optionally encode a set of displacement vectors associated with the subdivided mesh vertices, referred to as the displacement field d (i). These displacement vectors are computed in the pre-processing module based on the original mesh data, the update displacements module or circuit recomputes the displacement vectors based on the base mesh decoded and reconstructed values (after static mesh decoding);
Wavelet transform module or circuit 1110: applies subdivision and linear filter operations on the updated displacement vectors. The output are wavelet coefficient triplets per vertex at each subdivision level;
Quantization module or circuit 1112: quantization of the wavelet coefficients, which may be uniform or adaptive
Image packing module or circuit 1114: performs packing of the quantized wavelet coefficients in a video component;
Video Encoding module or circuit 1116: performs encoding of the packed wavelet coefficients video component with a 2D video codec such as HEVC, VVC, and the like;
Image unpacking module or circuit 1118: after decoding, the reconstructed wavelet coefficients are unpacked from the decoded and reconstructed video component by the image unpacking module or circuit 1118;
Inverse quantization module or circuit 1120: is symmetric with the quantization module chosen for wavelet coefficients;
Inverse wavelet transform module or circuit 1122: subdivision and linear filtering that enables the reconstruction of the decoded displacement vectors;
Reconstruct deformed mesh module or circuit 1124: applies the decoded displacement vectors to the decoded reconstructed (and inverse quantized) base mesh and chosen subdivision levels;
Attribute transfer module and circuit 1126: recomputes UV coordinates for the attribute video component;
Padding module or circuit 1128: fills the background of the attribute video component to enhance compression performance;
Color space conversion module or circuit 1130: applies color conversion before video coding when required
Video encoding module or circuit 1132: as above, any 2D video codec may be chosen such as HEVC or VVC to encode the attribute video component;
MUX module or circuit 1134: all sub-bitstreams (compressed displacements, compressed attribute map stream, compressed base mesh stream and patch information) are muxed together by the mux module or circuit 1134 to form the output bitstream;
Control module or circuit 1136: the control module or circuit 1136 uses information from all intermediate steps to fine tune and adapt parameters when necessary for the subsequent steps for the current frame or next frames

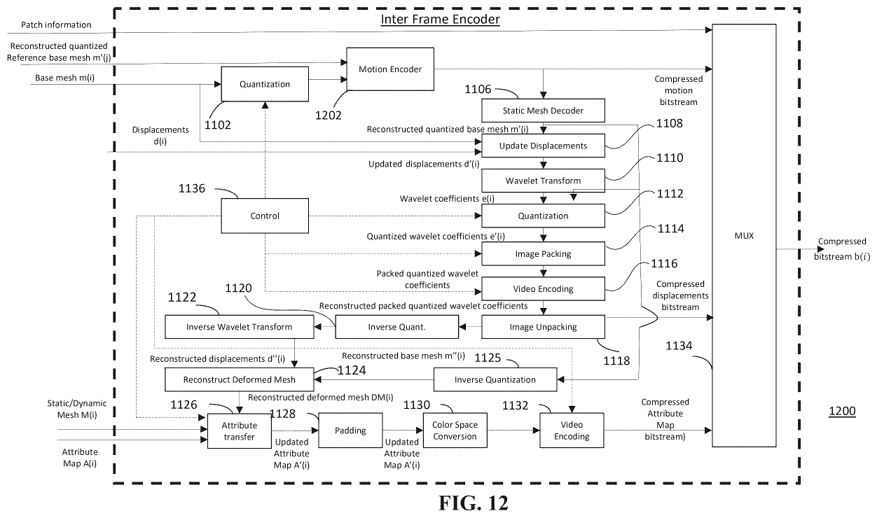

FIG. 12 illustrates inter frame encoder scheme 1200. In inter frame encoder scheme 1200, a base mesh connectivity of the first frame of a group of frames is imposed to the subsequent frame's base meshes to improve compression performance. The inter frame encoder scheme 1200 is similar to the intra frame encoder scheme 1100 and includes similar modules and circuits. However, the base mesh connectivity, in the inter frame encoder scheme 1200, may be constrained for all frames of a group of frames. Further, a motion encoder 1202 may be used to efficiently encode displacements between base meshes compared to the base mesh of the first frame of the group of frames, which may also be referred to as reference base mesh, is encoded with a static mesh encoder.

The compressed bitstream generated by the encoder multiplexes, for example, at least two or more of following:
A sub-bitstream with the encoded base mesh using a static mesh codec;
A sub-bitstream with the encoded motion data using an animation codec for base meshes in case INTER coding is enabled;
A sub-bitstream with the wavelet coefficients of the displacement vectors packed in an image and encoded using a video codec;
A sub-bitstream with the attribute map encoded using a video codec; or
A sub-bitstream that contains all metadata required to decode and reconstruct the mesh sequence based the on aforementioned sub-bitstreams. The signalling of the metadata is based on the V3C syntax and includes necessary extensions that are specific to meshes.

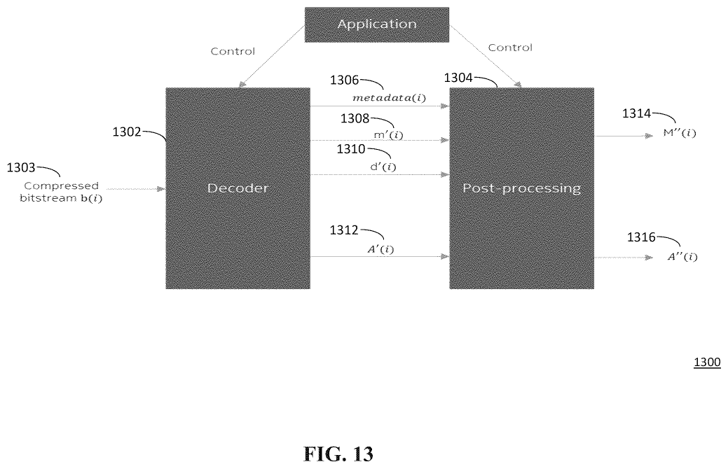

FIG. 13 illustrates a decoding module or circuit 1300. The decoding module or circuit 1300 includes a decoder 1302 and a post-processing module or circuit 1304. The decoder 1302 demultiplexes a compressed bitstream 1303 into sub-bitstreams that are reconstructed, e.g., metadata 1306, a reconstructed base mesh m′ (i) 1308, reconstructed displacements d′ (i) 1310, and a reconstructed attribute map data A′ (i) 1312. The reconstruction of the mesh sequence is performed, based on the reconstructed attribute map data A′ (i) 1312, by the post-processing module or circuit 1304 to generate dynamic mesh M″ (i) 1314 and a dynamic reconstructed attribute map data A″ (i) 1316. The decoder module or circuit 1302 demuxes and decodes all sub-streams, and the post-processing module or circuit 1304 reconstructs the dynamic mesh sequence.

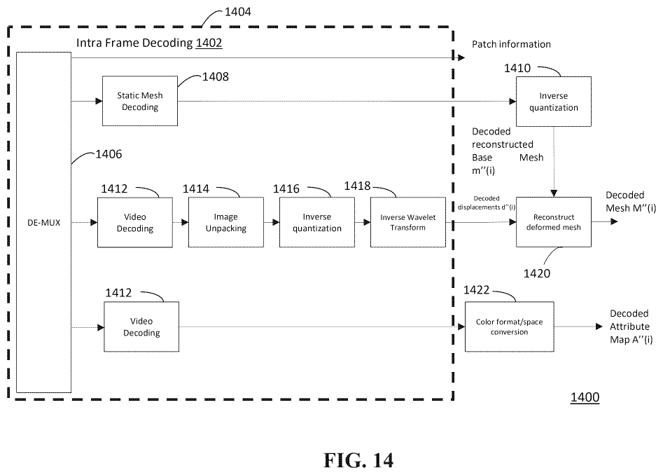

FIG. 14 illustrates intra process decoding scheme 1400. The intra process decoding scheme 1400 in includes following:
a decoder 1402 performs the same reconstruction operations as the decoder available at the encoder-side. The modules or circuits inside the dashed rectangle 1404 correspond to the decoder operations, while modules outside of it correspond to rendering or post-processing operations;
De-MUX 1406: demuxes the bitstream into the patch information, compressed displacements stream, compressed attribute map stream and compressed base mesh stream;
static mesh decoder 1408: the static mesh decoder 1408 may be the same as the one used at the encoder side, it outputs a reconstructed base mesh;
Inverse quantization module or circuit 1410: performs inverse quantization of decoded static mesh in the same manner as in the encoder;
Video Decoding module or circuit 1412: the video decoder should match the video encoder chosen at the encoder-side. One instance generates a decoded displacement video component. Another instance generates the decoded attribute map;
Image unpacking module or circuit 1414: the decoded displacement video component is unpacked to output the compressed wavelet coefficients;
Inverse quantization module or circuit 1416: the decoded and unpacked wavelet coefficients undergo inverse quantization as in the encoder;
Inverse wavelet transform module or circuit 1418: the subdivision and linear inverse wavelet filters are applied as in the encoder to generate the reconstructed decoded displacements;
Reconstruct deformed mesh module or circuit 1420: this module combines the decoded and inverse quantized base mesh with the subdivisions and decoded displacements to generate an output mesh.
Color space conversion module or circuit 1422: when required the decoded attribute map video component undergoes a color space conversion.

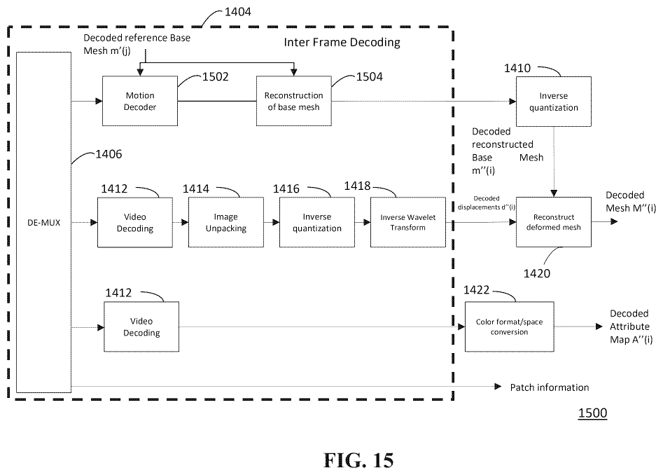

FIG. 15 illustrates inter process decoding scheme 1500. The inter process decoding scheme 1500 includes similar modules and circuits as in described with reference to FIG. 14, with a change that a decoded reference base mesh is stored in a buffer that is used by a motion decoder 1502 to generate the decoded base mesh 1504 for the current frame. In an embodiment, this reference base mesh is specific to inter encoding and decoding schemes. The current frame decoded base mesh includes a combination of the decoded and reconstructed reference base mesh (encoded with a static mesh encoder) and the decoded motion information.

The signalling of the metadata and substreams produced by the encoder (e.g., the encoder 1200 or the encoder 1300) and ingested by the decoder was proposed as an extension of V3C in the technical submission to the dynamic mesh coding CfP, and should be considered as purely indicative for the moment. The signaling is proposed as following and in additional V3C unit header syntax, includes V3C unit payload syntax, and Mesh Intra patch data unit.

### V3C Unit Header Syntax

| | Descriptor |
|---|---|
| v3c_unit_header( ) { | |
| vuh_unit_type | u(5) |
| if( vuh_unit_type == V3C_AVD \|\| vuh_unit_type | |
| == V3C_GVD \|\| | |
| vuh_unit_type == V3C_OVD \|\| vuh_unit_type == | |
| V3C_AD \|\| | |
| vuh_unit_type==V3C_MD) { | |
| vuh_v3c_parameter_set_id | u(4) |
| vuh_atlas_id | u(6) |
| } | |
| ... | |
| else if( vuh_unit_type==V3C_MD ) { | |
| vuh_mesh_data_sample_stream_flag | u(1) |
| vuh_mesh_data_motion_field_present_flag | u(1) |
| vuh_reserved_zero_15bits | u(15) |
| } | |
| Else | |
| vuh_reserved_zero_27bits | |
| } | |

### V3C Unit Payload Syntax

Descriptor

```
v3c_unit_payload( numBytesInV3CPayload ) {
  if( vuh_unit_type == V3C_VPS )
  v3c_parameter_set( numBytesInV3CPayload )
  else if( vuh_unit_type == V3C_AD)
  atlas_sub_bitstream( numBytesInV3CPayload )
  else if( vuh_unit_type == V3C_MD)
    mesh_sub_bitstream(
numBytesInV3CPayload)
  else if( vuh_unit_type == V3C_OVD ||
    vuh_unit_type == V3C_GVD ||
    vuh_unit_type == V3C_AVD)
  video_sub_bitstream( numBytesInV3CPayload )
}
```

### Mesh Intra Patch Data Unit

| | Descriptor |
|---|---|
| mesh_intra_patch_data_unit( tileID, patchIdx ) { | |
| mdu_patchgroup_index[ tileID ][ patchIdx ] | ue(v) |
| mdu_patch_parameters_enable_flag[ tileID | u(1) |
| ][patchIdx ] | |
| mdu_geometry_2d_ pos_x[ tileID ][ patchIdx ] | ue(v) |
| mdu_geometry_2d_pos_y[ tileID ][ patchIdx ] | ue(v) |
| mdu_geometry_2d_size_x_minus1[ tileID ][ patc | ue(v) |
| hIdx ] | |
| mdu_geometry_2d_size_y_minus1[ tileID ][ patc | ue(v) |
| hIdx ] | |
| mdu_attributes_2d_pos_x[ tileID ][ patchIdx ] | ue(v) |
| mdu_attributes_2d_pos_y[ tileID ][ patchIdx ] | ue(v) |
| mdu_attributes_2d_size_x_minus1[ tileID ][ pa | ue(v) |
| tchIdx ] | |
| mdu_attributes_2d_size_y_minus1[ tileID ][ pa | ue(v) |
| tchIdx ] | |
| mdu_3d_offset_u[ tileID ][ patchIdx ] | ue(v) |
| mdu_3d_offset_v[ tileID ][ patchIdx ] | ue(v) |
| mdu_3d_offset_d[ tileID ][ patchIdx ] | ue(v) |
| if( asps_normal_axis_max_delta_value_enabled_{—} | |
| flag ) | |
| mdu_3d_range_d[ tileID ][ patchIdx ] | ue(v) |
| mdu_vertex_count_minus1[ tileID ][ patchIdx ] | ue(v) |
| mdu_triangle_count_minus1[ tileID ][ patchIdx | ue(v) |
| ] | |
| mdu_head_vertex_index[ tileID ][ patchIdx ] | ue(v) |
| mdu_num_sequential_vertex_index[ tileID ][ pa | ue(v) |
| tchIdx ] | |
| for(v=0; v<= mdu_vertex_count_minus1− | |
| mdu_num_sequential_vertex_index; v++) { | |
| mdu_vertex_index_diff[ tileID ][ patchIdx ] | se(v) |
| } | |
| if( vmc_ext_direct_attribute_projection_enabl | |
| ed ) { | |
| mdu_projection_id[ tileID ][ patchIdx ] | u(v) |
| mdu_orientation_index[ tileID ][ patchIdx ] | u(v) |
| } | |
| if( afps_lod_mode_enabled_flag ) { | |
| mdu_lod_enabled_flag[ tileID ][ patchIdx ] | u(1) |
| if( mdu_lod_enabled_flag[ tileID ][ patchIdx | |
| ] > 0 ) { | |
| mdu_lod_scale_x_minus1[ tileID ][ patchIdx ] | ue(v) |
| mdu_lod_scale_y_idc[ tileID ][ patchIdx ] | ue(v) |
| } | |
| } | |
| if( mdu_patch_parameters_enable_flag ) { | |
| mdu_subdivision_enable_flag | u(1) |
| mdu_displacement_coordinate_system_enable_fla | u(1) |
| g | |
| mdu_transform_index_enable_flag | u(1) |
| mdu_transform_parameters_enable_flag | u(1) |
| mdu_num_attribute_enable_flag | u(1) |
| } | |
| if( mdu_subdivision_enable_flag ) { | |
| mdu_subdivision_method | ue(v) |
| mdu_subdivision_iteration_count_minus1 | ue(v) |
| } | |
| if( mdu_displacement_coordinate_system_enable | |
| _flag ) | |
| mdu_displacement_coordinate_system | ue(v) |
| if(mdu_transform_index_enable_flag) | |
| mdu_transform_index | ue(v) |
| if( mdu_transform_index != NONE && | |
| mdu_transform_parameters_enable_flag ) | |
| mdu_transform_parameters (0, mdu_transform_in | |
| dex) | |
| if( mdu_num_attribute_enable_flag ) | |
| mdu_num_attribute | ue(v) |
| for( i=0; i< mdu_num_attribute; i++ ) { | |
| mdu_attribute_type[ i ] | ue(v) |
| mdu_attribute_transform_index_enable_flag[ i | u(1) |
| ] | |
| mdu_attribute_transform_parameters_enable_fla | u(1) |
| g[ i ] | |
| if(mdu_attribute_transform_index_enable_flag[ | |
| i ]) | |
| mdu_attribute_transform_index[ i ] | ue(v) |
| if(mdu_attribute_transform_index[ i ] != | |
| NONE && mdu_attribute_transform_parameters | |
| _enable_flag[ i ]) { | |
| mdu_transform_parameters(i+1, mdu_attribute_{—} | |
| transform_index[ i ]) | |
| } | |
| } | |
| } | |

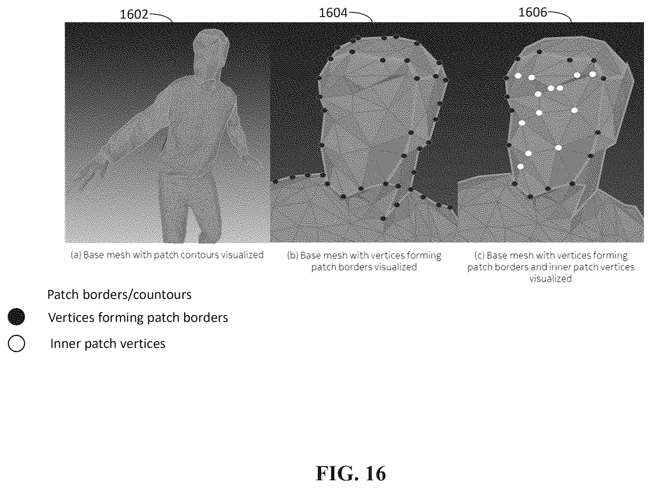

The mesh patch data unit includes a list of vertex indices of the decoded base mesh that identify the patch on the mesh. A single vertex may belong to multiple patches. The patches on the base mesh are illustrated in FIG. 16.

FIG. 16 illustrates visualization of patches on a base mesh. FIG. 16 is shown to include at least a base mesh with patch counters 1602 visualized; the base mesh with vertices forming 1604 and patch border 1606 visualized; and the base mesh with vertices forming 1604, patch borders 1606, and inner patch vertices 1608 visualized.

V3C applications like V-PCC and MIV compress volumetric video by converting 3D representations of volumetric frames into 2D representations and applying video coding on the 2D representations. The conversion from 3D space to 2D space is achieved through projection of 3D data onto 2D surfaces or patches, for example, by using real or virtual cameras to record the captured object or scene. As a result of this type of compression, cracks and artefacts frequently appear around the patch borders of the reconstructed decoded content. Major contributor to these cracks is the misalignment of reconstructed content around patch boundaries. This is a typical problem and has not been efficiently solved by the industry.

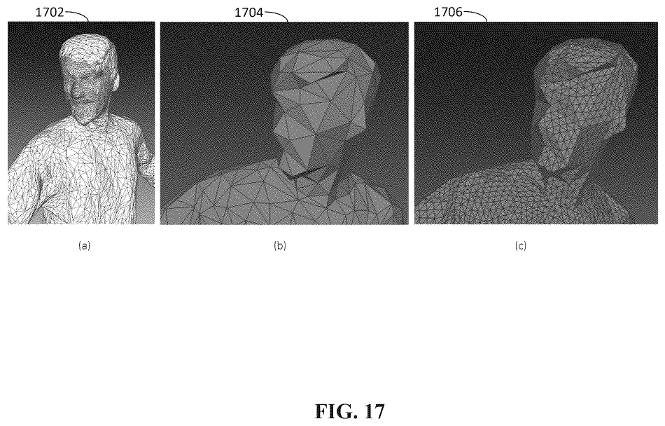

Recently MPEG 3DG (ISO/IEC SC29 WG7) has concluded the Call for Proposal (CfP) for dynamic compression of meshes, with the intention to define another V3C application. An example proposal relies on patching of input meshes similarly to other V3C applications such as MIV and V-PCC, but additionally signals a decimated base mesh as described in the background material and optional enhancement layers indicating displacement information for the vertices of the reconstructed mesh. The solution relies on subdividing the base mesh into a more granular mesh and displacing the generated vertices as indicated by the displacement information. An original mesh, a decimated base mesh, and a reconstructed mesh after applying a global subdivision modifier are illustrated in FIG. 17.

FIG. 17 illustrates an original mesh 1702, a decimated base mesh 1704, and a reconstructed mesh 1706 after applying a global subdivision modifier. The original mesh 1702 typically do not have a uniform density of triangles, but may have denser areas to convey more detail on salient areas such as the face of a person, often, when creating a base mesh 1704 with decimation, the density becomes more uniform, and uniform subdivision 1706 (here represented without recomputing vertex displacements) does not lead to a similar sampling when compared to the original mesh 1702. It is however possible to define different iteration counts for the subdivision per triangle of the base mesh 1704, and therefore obtain a denser sampling in selected areas of the mesh as in the original mesh 1702.

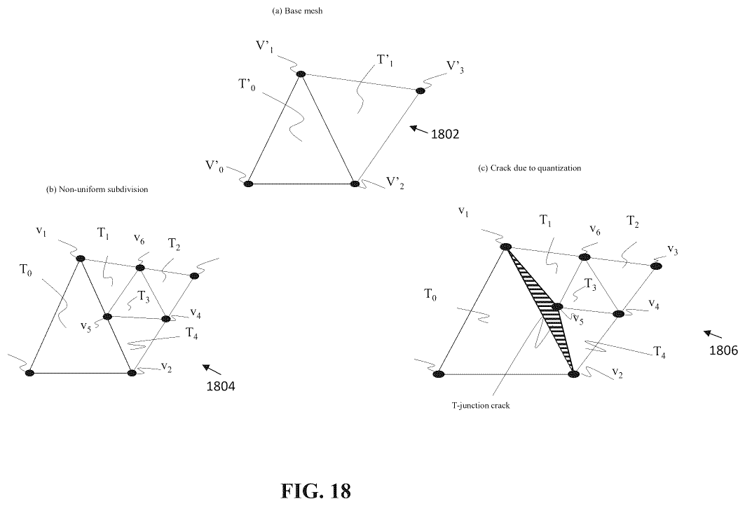

While the base-mesh 1704 may be considered water-tight, the subdivided mesh (with or without displacement information) may contain cracks between triangles which have different sub-division modifiers. This typically occurs at the edge of patches that have different sub-division modifiers, illustrated in FIG. 18.

FIG. 18 illustrates cracks between triangles TO and T1 after applying subdivision modifier to one triangle (e.g., the triangle T′1) and not the other. FIG. 18 is shown to include a base mesh 1802, the base mesh 1804 after non-uniform subdivision 1806, and a crack 1808 due quantization. The base mesh 1802 includes the triangles T′₀ and T′₁. The triangle T′₀ includes vertices V′₀, V′₁, and V′₃; and the triangle T′₁ includes vertices V′₁, V′₂, and V′₃. After applying the non-uniform subdivision to T′₁, the base mesh is transformed to include triangles T₀, T₁, T₂, T₃, and T₄. The triangle T₀ includes vertices V₀, V₁, and V₂; the triangle T₁ includes vertices V₁, V₅, and V₆; the triangle T2 includes vertices V₃, V₄, and V₆; the triangle T₃ includes vertices V₄, V₅, and V₆; the triangle T₄ includes vertices V₂, V₄, and V₅. After non-uniform subdivision the crack 1808 appears between the triangle T₀ and T₁.

A number of mesh ‘zipping’ algorithms may be implemented to help remedy the issues around the patch edges, but they mostly rely on identification of vertices that belong to the patch boundaries. The intention of the ‘zipping’ algorithms is to glue the vertices forming patch-boundaries together to remove the visible cracks that result from different sub-division modifiers or from other quantization errors.

The identification of vertices that form patch-boundaries results in additional processing for the decoder which has real-time performance requirements. An example algorithm for border vertex detection is described below:
First, the base mesh needs to be decoded from the V₃C mesh sub-bitstream to generate a list of vertices;
Second, mesh patch data units need to be decoded from V₃C atlas sub-bitstream to understand which vertices belong to which patches;
Third, identification of vertices that belong to multiple patch data units may be done by comparing vertex indices between mesh patch data units; and
Finally, the base mesh with the patch contours can be reconstructed.

However, it should be noted that, depending on the content, the process of identifying patch border vertices is not always as trivial. Planar mesh content may exist, where a vertex belongs at the edge of the patch but is not shared by other patches. In this case reconstruction of the base mesh is needed to identify such borders. Furthermore, patches may contain holes so that an edge exists within the patch, without connecting to any other patch. Detection of such edges may be close to impossible in real-time.

Instead of the previous process of analyzing the vertices in patch data (and possible 3D reconstruction), it should be possible to efficiently signal which vertices form patch edges.

Embodiments disclose an efficient method for signaling vertices that form patch-boundaries to help improving the performance of ‘zipping’ or other algorithms that rely on information about vertices that form patch boundaries. This information about patch-boundaries is vital for multiple algorithms that intend to improve the quality of the reconstructed mesh. Deriving information about patch boundaries is not trivially performed by the decoder and as such pre-calculating them and signaling them in the encoded bitstream is the rational thing to do. Therefore, adding the signaling in the bitstream can significantly improve the coding performance and reconstruction quality at the decoder.

Patch boundaries may be identified during the encoding process of dynamic meshes by comparing the vertex indices between different patches. Alternatively, an already encoded mesh may be analyzed to derive such information, by comparing the indices in the mesh patch data units. Information regarding the identified vertices, that form patch contours, may be signaled, for example, by using one or more flags. In an example, syntax of a mesh patch data unit may be extended to incorporate the one or more flags. The mesh patch data unit may thereafter be encoded, for example, in V3C atlas sub-bitstream that forms part of a V3C bitstream.

A receiver/decoder which obtains the bitstream, for example, the V3C bitstream can easily identify patch contour vertices by parsing the mesh patch data unit with the new flag. As a result, the decoder does not need to do additional processing to derive patch border vertices, and decoder performance is improved.

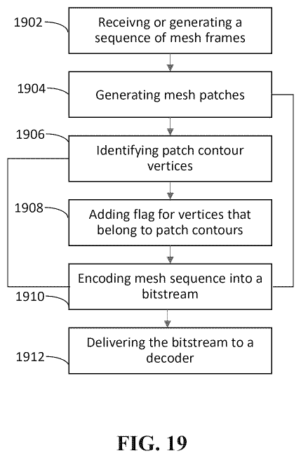

FIG. 19 describes a method 1900 for signaling information for vertices that form patch boundaries, in accordance with an embodiment. In an example, the signaling information may be flagged, for example, in the V3C bitstream. It should be noted that the identification of patch contour vertices may be done either before encoding the mesh patch information in the bitstream or thereafter. In an example, the patch contour information is encoded in the bitstream before providing the bitstream to the decoder. In an embodiment, the method 1900 may be divided into two separate methods to illustrate the different approaches. The method 1900 is described by using flag as an example for signaling information for the one or more vertices that form the one more patch boundaries. However, it should be noted that any other technique or data structure may be used for signaling this information.

At 1902, the method 1900 includes receiving or generating a sequence of mesh frames. At 1904, the method includes generating mesh patches. At 1906, the method includes identifying patch contour vertices. In an embodiment, patch border vertices may be identified by analyzing the vertex indices in different mesh patch data units. However, it should be noted that in some example implementations, (e.g., depending on the content) the process for identifying patch border vertices may be complex. For example, planar mesh content may exist, where a vertex belongs at the edge of the patch but is not shared by other patches; or holes may exist within patches, creating edges inside a patch that are not connected to any other patch. An example algorithm for connectivity analysis is described below:
for each edge (e) comprising vertices (v0, v1) in a set of edges of the mesh (E):
   when the e is connected to one polygon (P), e is a boundary edge, and v0 and v1 are boundary vertices for a patch comprising P;
   when e is connected to two polygons (P1 and P2):
      when P1 and P2 belong to different patches, e is a boundary edge;
      when P1 and P2 do not belong to the different patches, e is not a boundary edge;
for each detected boundary edge e comprising vertices indices v0 and v1, v0 and v1 are set as boundary vertices.

With this method, vertices are be visited as many times they show up in an edge. It may be that for some edges, the vertex is not identified as boundary. However, for at least one edge the vertex is identified as boundary; in that case the vertex is flagged as boundary. for example, a vertex is a boundary vertex when it has been detected as boundary vertex for at least one edge it belongs to. At 1908, the method 1900 includes adding flag for vertices that belong to patch contours. At 1910, the method 1900 includes encoding mesh sequence into bitstream, for example, into a V3C bitstream.

In an embodiment, encoding (1910) is performed prior to identifying (1906) and adding (1908).

In an embodiment, at 1912, the method 1900 also includes delivering or signaling the bitstream to a decoder.

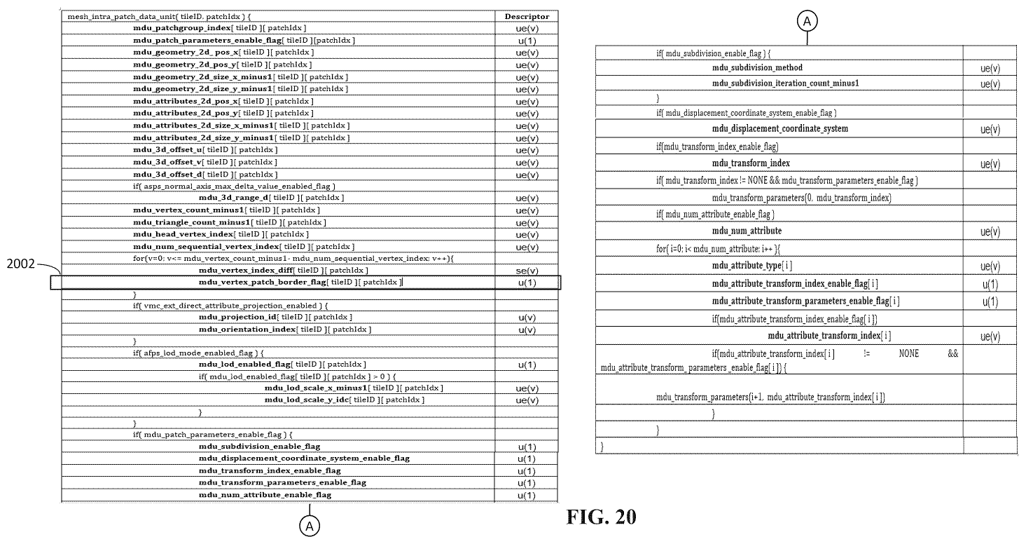

FIG. 20 illustrates extended syntax element 2002. As may be seen in FIG. 20, the signaling is efficient in that it only consumes one bit per vertex.

In an embodiment, mdu_vertex_patch_border_flag[tileID][patchIdx] equal to 0 indicates that the vertex identified in tileID and patchIdx does not belong on the border of the patch; and a value equal to 1 indicates that the vertex belongs on the border of the patch and as such is shared between other patches.

When the mesh patch data unit ends up including a list of vertices that form a patch on a mesh, as in the example FIG. 20, indication of the patch boundary vertices remains an important functionality.

### Some Benefits of One or More Embodiments

Some of the non-limiting benefits of one more embodiments are provided below:
Vertex border information at the decoder is directly available, thus decreasing computational load at the decoder. This information may be used for post-processing the reconstructed mesh, e.g., ‘zipping’, patch boundary filtering, and the like, thus improving reconstruction quality.
Accurate vertex border information generated by the decoder from original content avoids potential reconstruction artefacts from inaccurate vertex border information derived at the decoder from the reconstructed mesh (e.g., due to coding artefacts).
The approach may deal with patches in patches, disconnected patches, patches with holes, small or large patches in contrary to the prior art
Vertex border information is signaled efficiently with just 1 bit per vertex.
Enables error concealment (another application of it): in case of a hole, the boundary vertices around this hole may after base mesh compression be merged at the same 3D position, therefore closing the hole while connectivity indicates there is a hole. By reading that the vertices are boundary vertices, the decoder may shift their positions slightly to recreate the original small hole. This may be done by adapting the 3D reconstructed position of the boundary vertex by shifting it towards the center of gravity of its neighboring vertices that are not boundary vertices.

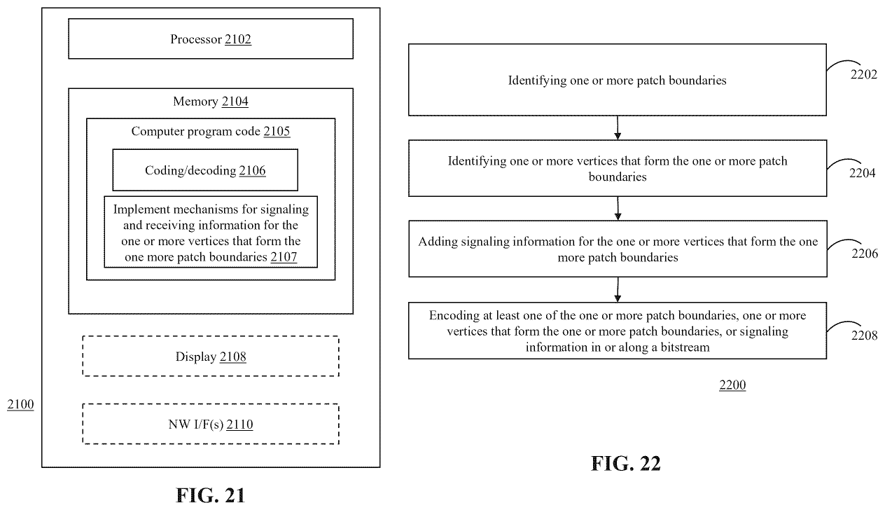

FIG. 21 is an apparatus 2100 which may be implemented in hardware, configured to perform signaling or receiving one or more boundary vertices, based on any of the examples described herein. The apparatus comprises a processor 2102, at least one memory 2104 (memory 2104 may be transitory or non-transitory) including computer program code 2105, wherein the at least one memory 2104 and the computer program code 2105 are configured to, with the at least one processor 2102, cause the apparatus to implement circuitry, a process, component, module, function, coding, and/or decoding (collectively 2106). The apparatus 2100 is further configured to implement mechanisms for signaling and/or receiving information for the one or more vertices that form the one more patch boundaries 2107, based on the embodiments described herein. The apparatus 2100 optionally includes a display and/or I/O interface 2108 that may be used to display an output (e.g., an image or volumetric video) of a result of coding/decoding 2106. The display and/or I/O interface 2108 may also be configured to receive input such as user input (e.g. with a keypad). The apparatus 2100 also includes one or more network (NW) interfaces (I/F(s)) 2110. The NW I/F(s) 2110 may be wired and/or wireless and communicate over a channel or the Internet/other network(s) via any communication technique. The NW I/F(s) 2110 may comprise one or more transmitters and one or more receivers. The NW I/F(s) 2110 may comprise standard well-known components such as an amplifier, filter, frequency-converter, (de) modulator, and encoder/decoder circuitry (ies) and one or more antennas. In some examples, the processor 2102 is configured to implement coding/decoding 2106, receiving, and/or signaling 2107 without use of memory 2104.

The apparatus 2100 may be a remote, virtual or cloud apparatus. The apparatus 2100 may be either a writer or a reader (e.g., parser), or both a writer and a reader (e.g., parser). The apparatus 2100 may be either a coder or a decoder, or both a coder and a decoder. The apparatus 2100 may be a user equipment (UE), a head mounted display (HMD), or any other fixed or mobile device.

The memory 2104 may be implemented using any suitable data storage technology, such as semiconductor based memory devices, flash memory, magnetic memory devices and systems, optical memory devices and systems, fixed memory and removable memory. The memory 2104 may comprise a database for storing data. Interface 2112 enables data communication between the various items of apparatus 2100, as shown in FIG. 21. Interface 2112 may be one or more buses, or interface 2112 may be one or more software interfaces configured to pass data within computer program code 2105. For example, the interface 2112 may be one or more buses such as address, data, or control buses, and may include any interconnection mechanism, such as a series of lines on a motherboard or integrated circuit, fiber optics or other optical communication equipment, and the like. In another example, interface 2112 is an object-oriented software interface. The apparatus 2100 need not comprise each of the features mentioned, or may comprise other features as well. The apparatus 2100 may be an embodiment of and have the features of any of the apparatuses shown in FIG. 1A, FIG. 1B, FIG. 5, FIG. 6, FIG. FIG. 9, FIG. 10, FIG. 11, FIG. 12, FIG. 13, FIG. 14, or FIG. 15.

FIG. 22 is method 2200 to implement the examples described herein, in accordance with an embodiment. As shown in block 2106 of FIG. 21, the apparatus 2100 includes means, such as the processing circuitry 2102 or the like, for coding or encoding. Further, as shown in block 2107 of FIG. 21, the apparatus 2100 includes means, such as the processing circuitry 2102 or the like, to implement mechanisms for signaling information for the one or more vertices that form the one more patch boundaries. At 2202, the method 2200 includes identifying one or more patch boundaries. At 2204, the method 2200 includes identifying one or more vertices that form the one or more patch boundaries. At 2206, the method 2200 includes adding signaling information for the one or more vertices that form the one more patch boundaries. At 2208, the method 2200 includes encoding at least one of the one or more patch boundaries, one or more vertices that form the one or more patch boundaries, or signaling information in or along a bitstream. In an embodiment, the method 1900 comprises using one or more flags for adding the signaling information.

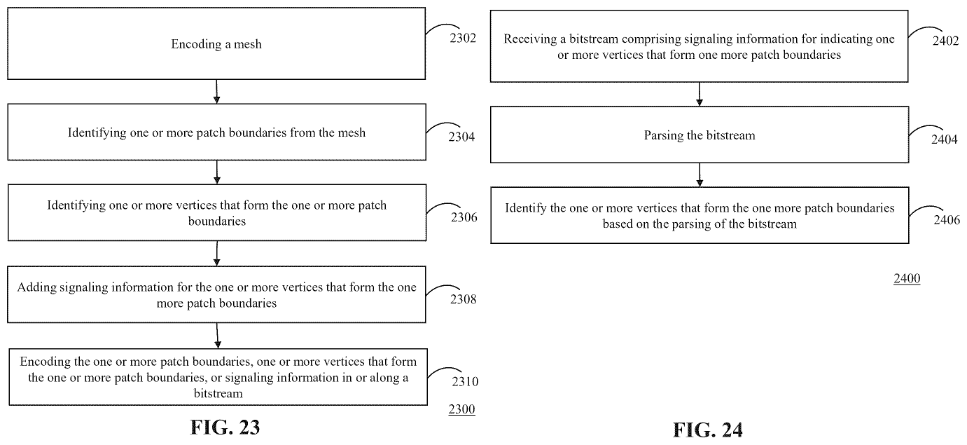

FIG. 23 is method 2300 to implement the examples described herein, in accordance with another embodiment. As shown in block 2106 of FIG. 21, the apparatus 2100 includes means, such as the processing circuitry 2102 or the like, for coding or encoding. Further, as shown in block 2107 of FIG. 21, the apparatus 2100 includes means, such as the processing circuitry 2102 or the like, to implement mechanisms for signaling information for the one or more vertices that form the one more patch boundaries. At 2302, the method 2300 includes encoding a mesh. At 2304, the method 2300 includes identifying one or more patch boundaries from the mesh. At 2306, the method 2300 includes: identifying one or more vertices that form the one or more patch boundaries. At 2308, the method 2300 includes adding signaling information for the one or more vertices that form the one more patch boundaries. At 2310, the method 2300 includes encoding the one or more patch boundaries, one or more vertices that form the one or more patch boundaries, or signaling information in or along a bitstream. In an embodiment, the method 2300 comprises using one or more flags for adding the signaling information.

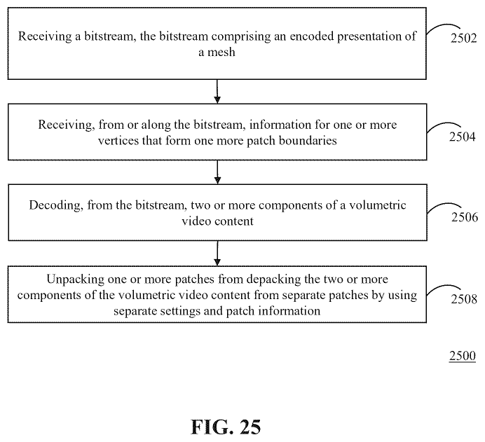

FIG. 24 is a method 2400 to implement the examples described herein, in accordance with an embodiment. As shown in block 2106 of FIG. 21, the apparatus 2100 includes means, such as the processing circuitry 2102 or the like, for decoding. Further, as shown in block 2107 of FIG. 21, the apparatus 2100 such includes means, as the processing circuitry 2102 or the like, to implement mechanisms for receiving information for the one or more vertices that form the one more patch boundaries. At 2402, the method 2400 includes receiving a bitstream comprising signaling information for indicating one or more vertices that form one more patch boundaries. At 2404, the method 2400 includes parsing the bitstream. At 2406, the method 2400 includes identify the one or more vertices that form the one more patch boundaries based on the parsing of the bitstream. In an embodiment, the signaling information is signaled by using one or more flags. In an embodiment, the bitstream further includes one or more patch boundaries, or one or more vertices that form the one or more patch boundaries.

FIG. 25 is a method 2500 to implement the examples described herein, in accordance with another embodiment. As shown in block 2106 of FIG. 21, the apparatus 2100 includes means, such as the processing circuitry 2102 or the like, for decoding. Further, as shown in block 2107 of FIG. 21, the apparatus 2100 includes means, such as the processing circuitry 2102 or the like, to implement mechanisms for receiving information for the one or more vertices that form the one more patch boundaries. At 2502, the method 2500 includes receiving a bitstream, the bitstream comprising an encoded presentation of a mesh. At 2504, the method 2500 includes receiving, from or along the bitstream, information for one or more vertices that form one more patch boundaries. At 2506, the method 2500 includes decoding, from the bitstream, two or more components of a volumetric video content. At 2508, the method 2500 includes unpacking one or more patches from depacking the two or more components of the volumetric video content from separate patches by using separate settings and patch information.

In an embodiment, the two or more components comprise two or more of an occupancy, a geometry, an attribute, a mesh component, or a displacement component. In an embodiment, the mesh component and the displacement component may be introduced due to extension to meshes. In an example, the displacement component may be considered as a specific type of the attribute component. The two or more components may comprise, for example, occupancy and geometry; or mesh and attribute, and the like.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

As used herein, the term ‘circuitry’ may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory (ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. Circuitry may also be used to mean a function or a process, such as one implemented by an encoder or decoder, or a codec.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows:
2D or 2d two-dimensional
3D or 3d three-dimensional
6DOF six degrees of freedom
ACL atlas coding layer
afps atlas frame parameter set
AR augmented reality
ASIC application-specific integrated circuit
asps atlas sequence parameter set
CABAC context-adaptive binary arithmetic coding
CfP call for proposal
CGI computer-generated imagery
HMD head mounted display
HRD hypothetical reference decoder
id or ID identifier
Idx index
IEC International Electrotechnical Commission
I/F interface
I/O input/output
ISO International Organization for Standardization
LOD or lod level of detail
MPEG moving picture experts group
MPEG-I MPEG immersive
MR mixed reality
NAL or nal network abstraction layer
NW network
pos position
RBSP raw byte sequence payload
SEI supplemental enhancement information
se(v) syntax element coded by the signed integer exponent Golomb code, with the left bit first
SODB string of data bits
UE user equipment
ue(v) unsigned integer exponential Golomb coded syntax element with the left bit first
u(n) unsigned integer using n bits, e.g. u(1), u(2)
UV or uv coordinate texture, where “U” or “u” and “V” or “v” are axes of a 2D texture
u (v) unsigned integer, where the number of bits is determined by the value of other syntax elements
V3C visual volumetric video-based coding
V-PCC video-based point cloud coding/compression
VPS V3C parameter set
VR virtual reality
X horizontal axis
Y vertical axis

1-41. (canceled)

42. An apparatus comprising:
at least one processor; and
at least one memory including computer program code;
wherein the at least one memory and the computer program code are configured to, with the at least one processor, cause the apparatus at least to perform:
identifying one or more patch boundaries;
identifying one or more vertices that form the one or more patch boundaries;
adding signaling information for the one or more vertices that form one more patch boundaries; and
encoding at least one of the one or more patch boundaries, the one or more vertices that form the one or more patch boundaries, or the signaling information in or along a bitstream.

43. The apparatus of claim 42, wherein the apparatus is further caused to perform:
signaling the bitstream to a decoder.

44. The apparatus of claim 42, wherein the bitstream comprises a visual volumetric video-based coding (V3C) bitstream, and wherein mesh patch information is encoded in a sub-bitstream in or along the bitstream, and wherein the sub-bitstream comprises an atlas sub-bitstream.

45. The apparatus of claim 42, wherein to identify the one or more patch boundaries the apparatus is further caused to perform:
comparing vertex indices between different patches comprised in a mesh during an encoding process.

46. The apparatus of claim 45, wherein the apparatus is further caused to perform:
encoding the mesh.

47. The apparatus of claim 46, wherein identifying the one or more patch boundaries comprises identifying the one or more patch boundaries from the mesh.

48. An apparatus comprising:
at least one processor; and
at least one memory including computer program code;
wherein the at least one memory and the computer program code are configured to, with the at least one processor, cause the apparatus at least to:
receiving a bitstream comprising signaling information for indicating one or more vertices that form one more patch boundaries;
parsing the bitstream; and
identifying the one or more vertices that form the one more patch boundaries based on the parsing of the bitstream.

49. The apparatus of claim 48, wherein the apparatus is further caused to perform:
unpacking, from the bitstream, one or more components of a volumetric video content; and
unpacking one or more patches from unpacking the one or more components of the volumetric video content from separate patches by using separate settings and patch information.

50. The apparatus of claim 49, wherein the one or more components comprise one or more of an occupancy, a geometry, an attribute, a mesh component, or a displacement component.

51. The apparatus of claim 48, wherein the bitstream comprises a visual volumetric video-based coding (V3C) bitstream.

52. A method comprising:
identifying one or more patch boundaries;
identifying one or more vertices that form the one or more patch boundaries;
adding signaling information for the one or more vertices that form one more patch boundaries; and
encoding at least one of the one or more patch boundaries, the one or more vertices that form the one or more patch boundaries, or the signaling information in or along a bitstream.

53. The method of claim 52 further comprising: signaling the bitstream to a decoder.

54. The method of claim 52, wherein the bitstream comprises a visual volumetric video-based coding (V3C) bitstream, and wherein mesh patch information is encoded in a sub-bitstream in or along the bitstream, and wherein the sub-bitstream comprises an atlas sub-bitstream.

55. The method of claim 52, wherein to identify the one or more patch boundaries further comprises:
comparing vertex indices between different patches comprised in a mesh during an encoding process.

56. The method of claim 55 further comprising:
encoding the mesh.

57. The method of claim 56, wherein identifying the one or more patch boundaries comprises identifying the one or more patch boundaries from the mesh.

58. A method comprising:
receiving a bitstream comprising signaling information for indicating one or more vertices that form one more patch boundaries;
parsing the bitstream; and
identifying the one or more vertices that form the one more patch boundaries based on the parsing of the bitstream.

59. The method of claim 58 further comprising:
unpacking, from the bitstream, one or more components of a volumetric video content; and
unpacking one or more patches from unpacking the one or more components of the volumetric video content from separate patches by using separate settings and patch information.

60. The method of claim 59, wherein the one or more components comprise one or more of an occupancy, a geometry, an attribute, a mesh component, or a displacement component.

61. The method of claim 58, wherein the bitstream comprises a visual volumetric video-based coding (V3C) bitstream.
